(19) United States
(12) Patent Application Publication
(10) Pub. No.: US 2012/0124569 A1
(43) Pub. Date: May 17, 2012

(54) COMMUNICATION MIDDLEWARE APPARATUS FOR GUEST, COMMUNICATION MIDDLEWARE APPARATUS FOR HOST, AND DRIVING METHOD USING THE SAME

(75) Inventors: Choong-Bum PARK, Daejeon-si (KR); Hoon Choi, Daejeon-si (KR); Byung-Sung Park, Daejeon-si (KR); Kyung-Min Park, Daejeon-si (KR); Huy-Jung Uhm, Daejeon-si (KR); Mi-Ri Kim, Daejeon-si (KR); Eun-Ji You, Daejeon-si (KR)

(73) Assignees: INDUSTRY FOUNDATION OF CHONNAM NATIONAL UNIVERSITY, Gwangju-si (KR); THE INDUSTRY & ACADEMIC COOPERATION IN CHUNGNAM NATIONAL UNIVERSITY, Daejeon-si (KR)

(21) Appl. No.: 12/965,097

(22) Filed: Dec. 10, 2010

(30) Foreign Application Priority Data
Nov. 11, 2010 (KR) 10-2010-0112139

(51) Int. Cl. G06F 9/44

(52) U.S. Cl. 717/171

(57) ABSTRACT

There is provided a communication middleware apparatus for a host device, including: a profile manager configured to receive specification information of a guest device through a Low-rate Wireless Personal Area Network (LR-WPAN) module; an application program manager configured to search for an application program for a host device that has to be newly installed or updated, based on the specification information of the guest device, and to install or update the found application program for the host device in the host device; and a firmware manager configured to search for firmware for the guest device that has to be updated based on the specification information of the guest device, and to transmit the found firmware for the guest device to the guest device through the LR-WPAN module.

### CROSS-REFERENCE TO RELATED APPLICATION

This application claims the benefit under 35 U.S.C. §119(a) of a Korean Patent Application No. 10-2010-0112139, filed on Nov. 11, 2010, the entire disclosure of which is incorporated herein by reference for all purposes.

### BACKGROUND

1. Field

The following description relates to a communication middleware apparatus and method that can improve users' or developers' convenience upon data transmission/reception between host and guest devices through a Low-rate Wireless Personal Area Network (LR-WPAN).

2. Description of the Related Art

With development of IT technology, various IT devices have been introduced. With this, a communication technology for data transmission/reception between various IT devices has also being developed. In particular, a Near Field Communication (NFC) technology by which IT devices can move wirelessly and conveniently connect to a network for data transmission/reception makes rapid progress. The NFC technology includes, for example, a Low-rate Wireless Personal Area Network (LR-WPAN), Bluetooth, Wifi, infrared, Ultra Wide Band (UWB), etc.

The LR-WPAN, unlike other NFC technologies, can be used for devices that are characterized in low-speed data, low power consumption and low cost. Such devices configure a small network to be applied to home control, wired cable substitution, industry automation, a sensor network, etc., and their application range is more and more expanding.

For these reasons, studies into a communication middleware technology allowing users or developers to more conveniently use an LR-WPAN communication technology are more needed.

### SUMMARY

The following description relates to a communication middleware apparatus for a Low-rate Wireless Personal Area Network (LR-WPAN) that can improve users' and developers' convenience.

In one general aspect, there is provided a communication middleware apparatus for a host device, including: a profile manager configured to receive specification information of a guest device through a Low-rate Wireless Personal Area Network (LR-WPAN) module; an application program manager configured to search for an application program for a host device that has to be newly installed or updated, based on the specification information of the guest device, and to install or update the found application program for the host device in the host device; and a firmware manager configured to search for firmware for the guest device that has to be updated based on the specification information of the guest device, and to transmit the found firmware for the guest device to the guest device through the LR-WPAN module.

The application program manager may download the found application program for the host device through a communication module for communicating with an external storage.

The firmware manager may download the found firmware through a communication module for communicating with an external storage and transmit the downloaded firmware to the guest device through the LR-WPAN module.

The specification information may include at least one among an ID, a name, a manufacturer, a manufacturer's homepage address, host application program information, and firmware information of the guest device.

The communication module may be an Ethernet module.

The communication middleware apparatus may further include a data communication controller configured to control data transmission/reception through the LR-WPAN module or the communication module.

In another general aspect, there is provided a communication middleware apparatus for a guest device, including: a specification information manager configured to create specification information of the guest device and to transmit the specification information of the guest device to a host device through a Low-rate Wireless Personal Area Network (LR-WPAN) module; and a firmware manager configured to update, when receiving firmware information for the guest device from the host device through the LR-WPAN module, firmware for the guest device based on the firmware information for the guest device.

The specification information of the guest device may include at least one among an ID, a name, a manufacturer, a manufacturer's homepage address, host application program information, and firmware information of the guest device.

The communication middleware apparatus may further include a data communication controller configured to control data transmission/reception through the LR-WPAN module.

In another general aspect, there is provided a method of operating a communication middleware apparatus, including: receiving specification information of a guest device through a Low-rate Wireless Personal Area Network (LR-WPAN) module; searching for an application program for a host device that has to be newly installed or updated, based on the specification information of the guest device; installing or updating the found application program for the host device in the host device; searching for firmware for the guest device that has to be updated based on the specification information of the guest device; and transmitting the found firmware for the guest device to the guest device through the LR-WPAN module.

The method may further include downloading an application program for the host device through a communication module for communicating with an external storage.

The method may further include: downloading the found firmware for the guest device through a communication module for communicating with an external storage; and transmitting the downloaded firmware for the guest device to the guest device through the LR-WPAN module.

The specification information may include at least one among an ID, a name, a manufacturer, a manufacturer's homepage address, host application program information, and firmware information of the guest device.

The communication module may be an Ethernet module.

In another general aspect, there is provided a method of operating a communication middleware apparatus for a guest device, including: creating specification information of the guest device; transmitting, when receiving a signal for requesting the specification information of the guest device from a host device, the specification information of the guest device to the host device through a Low-rate Wireless Personal Area Network (LR-WPAN) module; and updating, when receiving firmware information for the guest device from the host device through the LR-WPAN module, firmware for the guest device based on the firmware information for the guest device.

The specification information for the guest device may include at least one among an ID, a name, a manufacturer, a manufacturer's homepage address, host application program information, and firmware information of the guest device.

Other features and aspects will be apparent from the following detailed description, the drawings, and the claims.

### BRIEF DESCRIPTION OF THE DRAWINGS

FIG. 1 is a diagram illustrating an example of a system using a Low-rate Wireless Personal Area Network (LR-WPAN).

FIG. 2 is a diagram illustrating an example of a host communication middleware apparatus for a host device.

FIG. 3 is a diagram illustrating an example of a guest communication middleware apparatus for a guest device.

FIG. 4 is a flowchart illustrating an example of a method in which the host communication middleware apparatus and the guest communication middleware apparatus operate.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

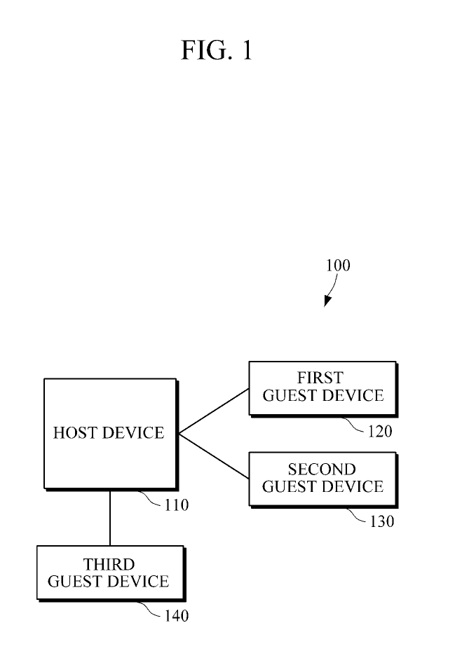

FIG. 1 is a diagram illustrating an example of a system 100 using a Low-rate Wireless Personal Area Network (LR-WPAN).

Referring to FIG. 1, the system 100 includes a host device 110, a first guest device 120, a second guest device 130 and a third guest device 140.

The host device 110, the first guest device 120, the second guest device 130 and the third guest device 140 each may include a LR-WPAN module. The host device 110 searches for the guest devices 120, 130 and 140 through the LR-WPAN module and connects to the found guest devices 120, 130 and 140. Accordingly, the host device 110 and the guest devices 120, 130 and 140 may receive or transmit data through the LR-WPAN module.

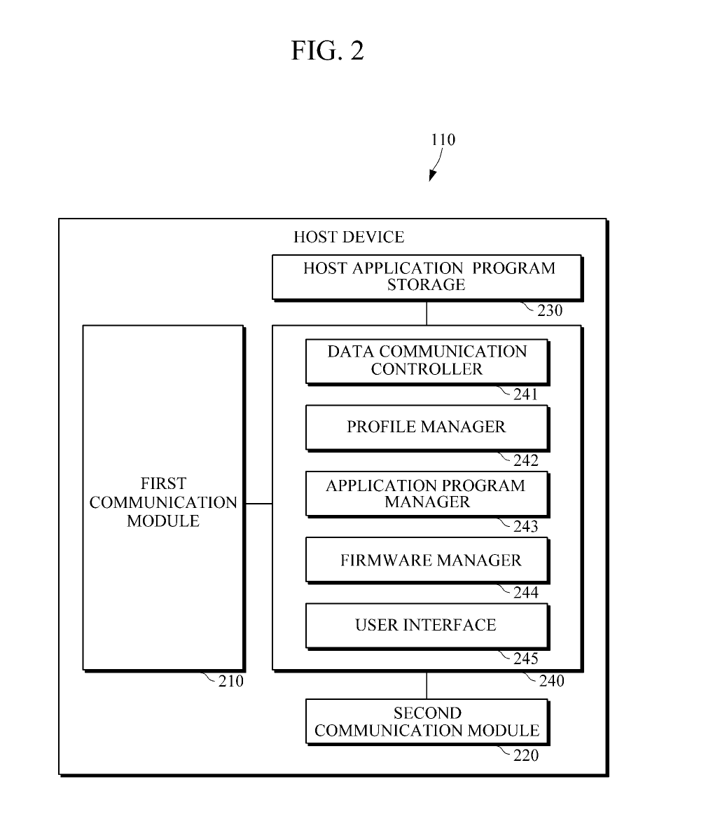

FIG. 2 is a diagram illustrating an example of a host communication middleware apparatus for the host device 110.

Referring to FIGS. 1 and 2, the host device 110 includes a first communication module 210, a second communication module 220, a host application program storage 230 and a host communication middleware apparatus 240.

The first communication module 210 is used for data transmission/reception between the host device 110 and a guest device (for example, one of the first, second and third guest devices 120, 130 and 140 illustrated in FIG. 1). For example, the first communication module 210 may be a LR-WPAN module.

The second communication module 220 is used for data transmission/reception between the host device 110 and an external storage. For example, the second communication module 220 may be an Ethernet module. The external storage may be a storage that can store application programs for the host device 110 or firmware information for the guest device. The external storage may update application programs for the host device or firmware information for the guest device periodically or occasionally. For example, the external storage may be a server or hardware including a communication module.

The host application program storage 230 may store application programs for the host device 110. The application programs may be application programs which the host device 110 has to install therein to use the guest device.

The host communication middleware apparatus 240 may include a data communication controller 241, a profile manager 242, an application program manager 243, a firmware manager 244 and a user interface 245.

The data communication controller 241 may control the first communication module 210 to transmit/receive data to/from the guest device. Also, the data communication controller 241 controls the second communication module 220 to transmit/receive data to/from an external storage.

The profile manager 242 may receive specification information of the guest device from the guest device through the first communication module 210. For example, the specification information of the guest device may be the ID, name, manufacturer, manufacturer's homepage address, host application program information and firmware information of the guest device. Also, the profile manager 242 may recognize the types, versions, etc. of the host application programs.

The application program manager 243 may search for or update host application programs based on the specification information of the guest device. For example, the application program manager 243 may search for or update host application programs depending on whether a list of host application programs included in the specification information of the guest device has been stored in the host application program storage 230. If the list of host application programs included in the specification information of the guest device has not been stored in the host device application program storage 230, the application program manager 243 recognizes host application programs included in the specification information of the guest device as host application programs that have to be newly installed. Also, when the versions of the host application programs included in the specification information of the guest device are different from those of the host application programs stored in the host application program storage 230, the application program manager 243 may recognize the host application programs included in the specification information of the guest device as host application programs that have to be updated. Then, the application program manager 243 stores the host application programs in the host device 110. That is, the application program manager 243 updates the host application programs. For example, the application program manager 243 uses the second communication module 220 to download the host application programs. The application program manager 243 may store the downloaded host application programs in the host application program storage 230. The application program manager 243 may update host application programs in response to a request from a user, etc. or may determine whether there is any latest host application program at regular time intervals to automatically update host application programs.

The firmware manager 244 may search for guest firmware that has to be updated based on the specification information of the guest device. For example, the firmware manager 24 may compare firmware version information included in the specification information of the guest device to the latest firmware version information to search for guest firmware that has to be updated. The firmware manager 244 may obtain information regarding the latest firmware version by receiving the latest firmware version information periodically or through an input from a user, etc.

The firmware manager 244 may transmit the guest firmware to the guest device through the first communication module 210. For example, if the firmware version included in the specification information of the guest device is lower than the latest firmware version, the firmware manager 244 may download the latest firmware through the second communication module 220 and transmit the downloaded latest firmware to the guest device.

The user interface 245 may represent the operating state of the host communication middleware apparatus 240 in the form of a menu, etc. for a user. If a user inputs a desired command through a menu, etc., the user interface 245 causes the host communication middleware apparatus to operate according to the command from the user. For example, the user interface 245 may display found guest devices. In this case, when a user selects one of the displayed guest devices, the user interface 245 may display the specification information of the selected guest device. The use interface 245 may be a Graphic User Interface (GUI).

By providing a host device based on a LR-WPAN communication standard with a host communication middleware apparatus that performs basic functions, such as searching for devices, identifying devices, connecting to devices or data exchange, instead of host application programs, a developer may easily develop various services and apparatuses by adding characteristic functions other than such basic functions to the host device. In other words, a developer can easily develop new application services or apparatuses by using the host communication middleware apparatus to provide basic functions and adding new functions developed by him or her.

Furthermore, the host communication middleware apparatus allows host application programs or guest firmware information to be easily updated, thereby improving users' convenience.

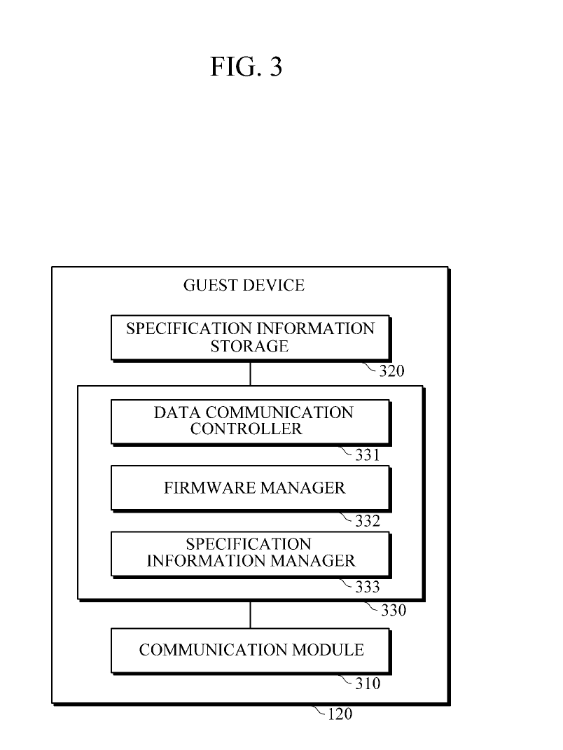

FIG. 3 is a diagram illustrating an example of a guest communication middleware apparatus 330 for the guest device 120.

Referring to FIGS. 1 and 3, the guest device 120 includes a communication module 310, a specification information storage 320 and a guest communication middleware apparatus 330.

The communication module 310 is used for data transmission/reception between host and guest devices. The guest device 120 may transmit data to the host device 110 through the communication module 310. For example, the communication module 310 may be a LR-WPAN module.

The specification information storage 320 may store the specification information of the guest device 120. For example, the specification information may be the ID, name, manufacturer, manufacturer's homepage address, host application program information, firmware information, etc. of the guest device.

The host communication middleware apparatus 330 may include a data communication controller 331, a firmware manager 332 and a specification information manager 333.

The data communication controller 331 may control the communication module 310 to transmit/receive data to/from the host device.

When guest firmware information is received from the host device through the communication module 310, the firmware manager 332 may update firmware based on the guest firmware information.

The specification information manager 333 may create the specification information for the guest device 120 and store the specification information in the specification information storage 320. Also, the specification information manager 333 may transmit, when receiving a signal for requesting specification information of the guest device 120 from the host device, the specification information to the host device.

By providing a guest device based on the LR-WPAN communication standard with a guest communication middleware apparatus that performs basic functions, such as searching for devices, identifying devices, connecting to devices or data exchange, instead of guest application programs, a developer may easily develop various services and apparatuses by adding characteristic functions other than such basic functions to the guest device. In other words, a developer can easily develop new application services or apparatuses by using the guest communication middleware apparatus to provide basic functions and adding new functions developed by him or her.

Furthermore, the guest communication middleware apparatus allows guest application programs or guest firmware information to be easily updated, thereby improving users' convenience. The communication module 310, the specification information storage guest 320, and the communication middleware apparatus 330 may be also applied to the guest devices 130 and 140, in the same way.

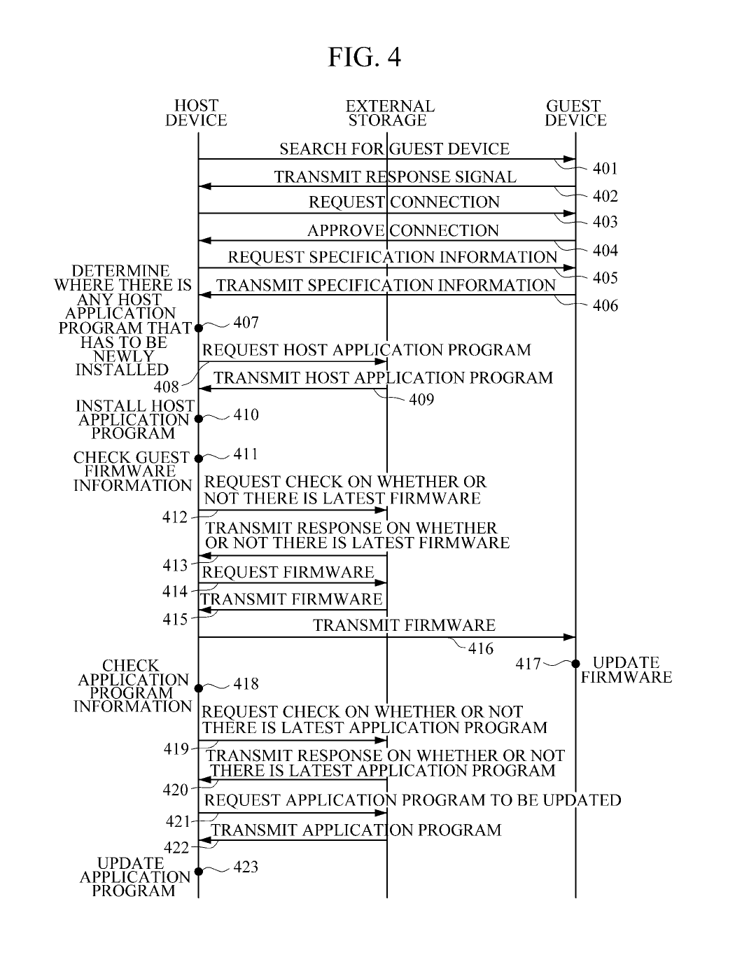

FIG. 4 is a flowchart illustrating an example of a method in which the host communication middleware apparatus and the guest communication middleware apparatus operate.

Referring to FIG. 4, a host device may search for a guest device by transmitting a search signal to the guest device (401). When receiving the search signal from the host device, the guest device may transmit a search response signal to the host device (402). Then, the host device may recognize that the guest device exists near the host device. Thereafter, the host device may transmit a connection request signal to the guest device (403). When receiving the connection request signal from the host device, the guest device transmits a connection approval signal to the host device (404). Accordingly, the host device is connected to the guest device. Then, the host device transmits a specification information request signal to the guest device (405). When receiving the specification information request signal from the host device, the guest device may transmit its specification information to the host device (406). The specification information may be stored in a specification information storage of the guest device. The host device may determine where there is any host application program that has to be newly installed based on the received specification information (407). When there is a host application program that has to be newly installed, the host device may request an external storage to send a host application program that has to be newly installed (408). When receiving a signal for requesting a host application program, the external storage may transmit the corresponding host application program to the host device (409). The host device may install the host application program therein (410). The process from operation 401 to operation 410 may be performed once when a host device first searches for a guest device.

The host device may check guest firmware information (411). For example, the firmware information may be information about the version of firmware. The host device may transmit a request signal for checking whether there is the latest firmware to the external storage (412). The external storage may transmit a response signal including information indicating whether or not there is the latest firmware to the host device (413). When it is determined that there is guest firmware that has to be updated based on the response signal, the host device may transmit a signal for requesting firmware to the external storage (414). When receiving the signal for requesting guest firmware, the external storage may transmit the corresponding guest firmware to the host device (415). The host device may transmit the received guest firmware to the guest device (416). The guest device may update firmware stored therein based on the received guest firmware (417). For example, the guest device substitutes the received guest firmware information for existing firmware information and store the guest firmware information therein.

The host device may check application program information (418). For example, the application program information may be the type of the corresponding application program. The host device may transmit a signal for determining whether there is the latest application program to the external storage (419). The external storage may transmit a response signal including information indicating whether or not there is the latest application program, to the host device (420). When it is determined that there is the latest application program based on the response signal, the host device may transmit a signal for requesting an application program that has to be updated to the external storage (421). When receiving the request signal, the external storage may transmit the corresponding application program to the host device (422). The host device may update an application program stored therein to the received application program (423). The process from operation 411 to operation 423 may be performed repeatedly at predetermined regular intervals.

According to the above-described method, it is possible to conveniently update application programs and firmware information for host and guest devices.

The above-described method may be implemented as processor-readable codes in a recording medium that stores programs. Examples of the recording medium include read-only memory (ROM), random access memory (RAM), CD-ROM, a magnetic tape, a floppy disk, an optical data storage, etc. Further, the recording media may be implemented in the form of a carrier wave (for example, transmission through the Internet).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication middleware apparatus for a host device, comprising:
a profile manager configured to receive specification information of a guest device through a Low-rate Wireless Personal Area Network (LR-WPAN) module;
an application program manager configured to search for an application program for a host device that has to be newly installed or updated, based on the specification information of the guest device, and to install or update the found application program for the host device in the host device; and
a firmware manager configured to search for firmware for the guest device that has to be updated based on the specification information of the guest device, and to transmit the found firmware for the guest device to the guest device through the LR-WPAN module.

2. The communication middleware apparatus of claim 1, wherein the application program manager downloads the found application program for the host device through a communication module for communicating with an external storage.

3. The communication middleware apparatus of claim 1, wherein the firmware manager downloads the found firmware through a communication module for communicating with an external storage and transmits the downloaded firmware to the guest device through the LR-WPAN module.

4. The communication middleware apparatus of claim 1, wherein the specification information includes at least one among an ID, a name, a manufacturer, a manufacturer's homepage address, host application program information, and firmware information of the guest device.

5. The communication middleware apparatus of claim 2, wherein the communication module is an Ethernet module.

6. The communication middleware apparatus of claim 2, further comprising a data communication controller configured to control data transmission/reception through the LR-WPAN module or the communication module.

7. A communication middleware apparatus for a guest device, comprising:
a specification information manager configured to create specification information of the guest device and to transmit the specification information of the guest device to a host device through a Low-rate Wireless Personal Area Network (LR-WPAN) module; and
a firmware manager configured to update, when receiving firmware information for the guest device from the host device through the LR-WPAN module, firmware for the guest device based on the firmware information for the guest device.

8. The communication middleware apparatus of claim 7, wherein the specification information of the guest device includes at least one among an ID, a name, a manufacturer, a manufacturer's homepage address, host application program information, and firmware information of the guest device.

9. The communication middleware apparatus of claim 7, further comprising a data communication controller configured to control data transmission/reception through the LR-WPAN module.

10. A method of operating a communication middleware apparatus, comprising:
receiving specification information of a guest device through a Low-rate Wireless Personal Area Network (LR-WPAN) module;
searching for an application program for a host device that has to be newly installed or updated, based on the specification information of the guest device;
installing or updating the found application program for the host device in the host device;
searching for firmware for the guest device that has to be updated based on the specification information of the guest device; and
transmitting the found firmware for the guest device to the guest device through the LR-WPAN module.

11. The method of claim 10, further comprising downloading an application program for the host device through a communication module for communicating with an external storage.

12. The method of claim 10, further comprising:
downloading the found firmware for the guest device through a communication module for communicating with an external storage; and
transmitting the downloaded firmware for the guest device to the guest device through the LR-WPAN module.

13. The method of claim 10, wherein the specification information includes at least one among an ID, a name, a manufacturer, a manufacturer's homepage address, host application program information, and firmware information of the guest device.

14. The method of claim 11, wherein the communication module is an Ethernet module.

15. A method of operating a communication middleware apparatus for a guest device, comprising:
creating specification information of the guest device;
transmitting, when receiving a signal for requesting the specification information of the guest device from a host device, the specification information of the guest device to the host device through a Low-rate Wireless Personal Area Network (LR-WPAN) module; and
updating, when receiving firmware information for the guest device from the host device through the LR-WPAN module, firmware for the guest device based on the firmware information for the guest device.

16. The method of claim 15, wherein the specification information for the guest device includes at least one among an ID, a name, a manufacturer, a manufacturer's homepage address, host application program information, and firmware information of the guest device.
